(19) United States
(12) Patent Application Publication
(10) Pub. No.: US 2024/0326715 A1
(43) Pub. Date: Oct. 3, 2024

(54) METHOD FOR INSTALLING AND UNINSTALLING A ROOF MOUNTED SENSOR POD

(71) Applicant: Kodiak Robotics, Inc., Mountain View, CA (US)

(72) Inventors: Jay Kuvelker, San Francisco, CA (US); Andreas Wendel, Mountain View, CA (US)

(21) Appl. No.: 18/129,710

(22) Filed: Mar. 31, 2023

(51) Int. Cl. B60R 11/04; G01D 11/24; G01D 11/30

(52) U.S. Cl. CPC B60R 11/04; G01D 11/245; G01D 11/30; B60R 2011/004; B60R 2011/0059

(57) ABSTRACT

A method of installing a sensor pod on a roof of a vehicle includes providing a connecting assembly having a vehicle portion configured to couple to the vehicle and a sensor pod portion attached to the sensor pod, installing the vehicle portion of the connecting assembly on the vehicle, coupling the sensor pod portion of the connecting assembly to the vehicle portion, after coupling the sensor pod portion to the vehicle portion, supporting the weight of the sensor pod with the connecting assembly, and securing the sensor pod to the vehicle portion of the connecting assembly. The connecting assembly supports the weight of the sensor pod before and after securing the sensor pod to the vehicle portion. A method of uninstalling a sensor pod is also provided.

### CROSS REFERENCE TO RELATED APPLICATIONS

The present application is related to co-pending U.S. Application Attorney Docket No. 143805.576667, filed Mar. 31, 2023, U.S. Application Attorney Docket No. 143805.577072, filed Mar. 31, 2023, and U.S. Application Attorney Docket No. 143805.577073, filed Mar. 31, 2023, the entire contents of each of which are hereby incorporated by reference in their entireties.

### TECHNICAL FIELD

The present disclosure relates to a roof mounted sensor pod.

### BACKGROUND

Autonomous and semi-autonomous vehicles include sensors to gather data and information, communicate with the vehicle, and assist in navigating the vehicle. The sensors may be mounted to the vehicle roof.

### BRIEF SUMMARY

A method of installing a sensor pod on a roof of a vehicle, the method including providing a connecting assembly having a vehicle portion configured to couple to the vehicle and a sensor pod portion attached to the sensor pod, installing the vehicle portion of the connecting assembly on the vehicle, coupling the sensor pod portion of the connecting assembly to the vehicle portion, after coupling the sensor pod portion to the vehicle portion, supporting the weight of the sensor pod with the connecting assembly, and securing the sensor pod to the vehicle portion of the connecting assembly. The connecting assembly supports the weight of the sensor pod before and after securing the sensor pod to the vehicle portion.

A method of uninstalling a sensor pod on a roof of a vehicle, the method including unsecuring a sensor pod portion of a connecting assembly from a vehicle portion of the connecting assembly, disconnecting one or more conduits from the sensor pod, removing the sensor pod portion from the vehicle portion to disconnect the sensor pod from the roof of the vehicle, and removing the sensor pod, wherein the vehicle portion is permanently fixed to the vehicle.

Additional features, advantages, and embodiments of the present disclosure are set forth or apparent from consideration of the following detailed description, drawings and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a perspective view of a vehicle with a sensor bar, according to an embodiment of the present disclosure.

FIG. 2 illustrates a perspective view of a vehicle with a sensor bar, according to an embodiment of the present disclosure.

FIG. 3 illustrates a top view of a sensor bar coupled to the vehicle of FIG. 1, according to an embodiment of the present disclosure.

FIG. 4 illustrates a partial, exploded perspective view of the sensor bar of FIG. 3, according to an embodiment of the present disclosure.

FIG. 5 illustrates a perspective view of an exemplary side sensor pod of the sensor bar of FIG. 3, according to an embodiment of the present disclosure.

FIG. 6 illustrates an installation step for installing the sensor pod of FIG. 3, according to an embodiment of the present disclosure.

FIG. 7 illustrates a partial, exploded perspective view of an interior sensor pod and a sensor bar

FIG. 8 illustrates a partial, exploded perspective view of an interior sensor pod and a sensor bar, according to an embodiment of the present disclosure.

FIG. 9A illustrates a partial, exploded perspective view of an interior sensor pod and a sensor bar, according to an embodiment of the present disclosure.

FIG. 9B illustrates a partial, exploded side view of the interior sensor pod and sensor bar of FIG. 9A, according to an embodiment of the present disclosure.

FIG. 10 illustrates a illustrates a perspective view of a vehicle with roof mounted side sensor pods, according to an embodiment of the present disclosure.

FIG. 11 illustrates a illustrates a perspective view of a vehicle with roof mounted side sensor pods and an interior sensor pod, according to an embodiment of the present disclosure.

FIG. 12 illustrates a perspective view of a bracket for a side sensor pod or interior sensor pod, according to an embodiment of the present disclosure.

FIG. 13A illustrates a perspective view of another bracket for a side sensor pod or interior sensor pod, according to an embodiment of the present disclosure.

FIG. 13B illustrates a side view of the bracket of FIG. 13A, according to an embodiment of the present disclosure.

FIG. 13C illustrates a perspective view of the bracket of FIG. 13A coupled to a sensor pod, according to an embodiment of the present disclosure.

FIG. 13D illustrates a perspective view of the bracket of FIG. 13A coupled to another sensor pod, according to an embodiment of the present disclosure.

FIG. 14A illustrates a perspective view of a vehicle, according to an embodiment of the present disclosure.

FIG. 14B illustrates a perspective view of another vehicle, according to an embodiment of the present disclosure.

FIG. 15 illustrates a process for installing a sensor pod, according to an embodiment of the present disclosure.

FIG. 16 illustrates a process for removing a sensor pod, according to an embodiment of the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “rearward” refer to relative positions of a vehicle. For example, forward refers to a position closer to front hood, front bumper, or front fender of the vehicle and rearward refers to a position closer to a rear bumper, rear trunk, or trailer of the vehicle.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “fix”, “fixate”, “fixed”, “rigid”, “rigidly” or the like refer to such a connection where relative movement is prevented or limited between two parts.

Vehicles include sensor pods connected to the vehicle. The sensor pods gather data and information, communicate with the vehicle, and may assist in navigating the vehicle. The sensor pods are connected to the vehicle by connecting assemblies. There remains a need for improved assemblies, systems, and methods for connecting sensor pods to vehicles. As described and shown herein, these may include, for example, a roof mounted sensor pods and sensor pod bars. The sensor pods of the present disclosure allow for swapping, interchanging, or replacing of full sensor pods from the vehicle in a quick, easy, and efficient manner. Therefore, the sensor pods of the present disclosure have connecting assemblies that allow for quick connection and disconnection from the vehicle and/or from brackets or bars attached to the vehicle. With such a connection, the sensor pods can be calibrated, recalibrated, repaired, interchanged, replaced, etc. without having to remove the entire mounting assembly (e.g., the frame or bracket) from the vehicle. This also allows removal and reinstallation of the sensor pods may be done without recalibrating all of the sensors.

In one aspect of the present disclosure, a sensor pod may flex back after an impact to reduce damage and debris after a collision. The connecting assembly may allow rotation on impact but is securely held with shear bolts to prevent vibration. In another aspect of the present disclosure, the quick swap sensor pod may be changed quickly, for example, in a few minutes. The connecting assembly allows for quick removal and/or install. Bolts are not required to initially mount the sensor pod to the vehicle. In another aspect, the connecting assembly provides for universal attachment for multiple mirror pod types and for universal attachment to multiple vehicle styles. In another aspect of the present disclosure, a sensor pod may be swapped by one individual without the need of additional support structures to manage the weight and positioning of the sensor pod.

In one aspect, the connecting assembly may include features to provide for alignment and position control of the sensor pod. For example, in a connecting assembly having a frame or a bracket and a sensor pod, as discussed in more detail below, the sensor pod and the frame or the bracket can be configured to provide for alignment and position control of the sensor pod when assembling the bracket and sensor pod. These features can reliably position the frame or bracket and sensor pod arm such that they are in contact and/or in touching contact with each other, as described in more detail below. Various frame or bracket and sensor pod contact configurations are contemplated, including one or more features to facilitate the alignment and/or contact. For example, in some examples, side surfaces of the frame or bracket and sensor pods are in alignment with each other and may be in contact with each other. In some examples, raised portions of the frame or bracket and the sensor pod arm are in alignment with each other and may be in contact with each other. Configurations that are compatible with manufacturing may be beneficial. The feature(s) and configurations can be configured, designed and/or manufactured to provide for reliable alignment and, in some examples, contact between the bracket and the sensor pod arm. The feature(s) can control a position of the sensor pod relative to the bracket and help align the connection between the sensor pod and the bracket. Details of the alignment, control, and in some examples, contact, are described in more detail to follow.

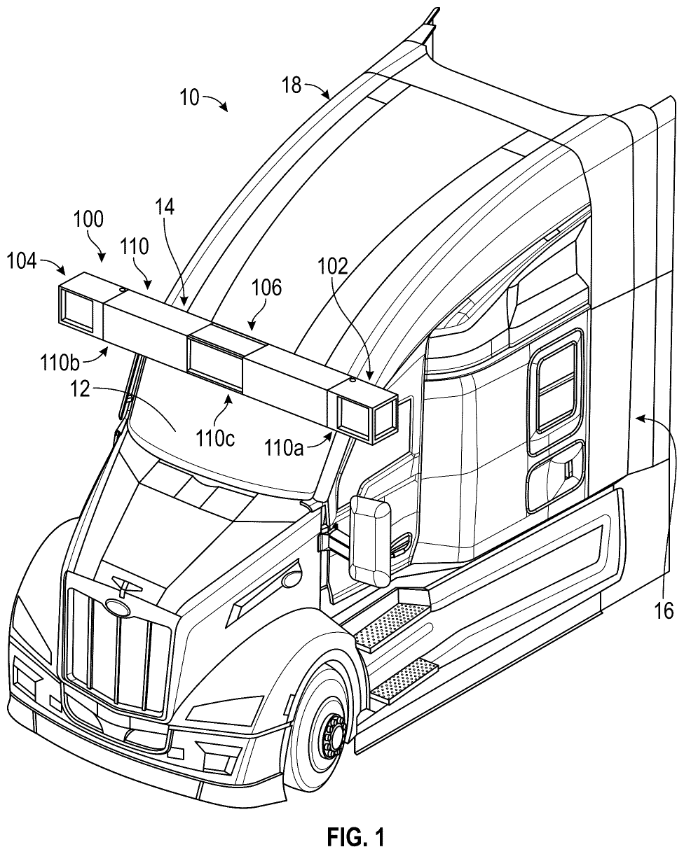

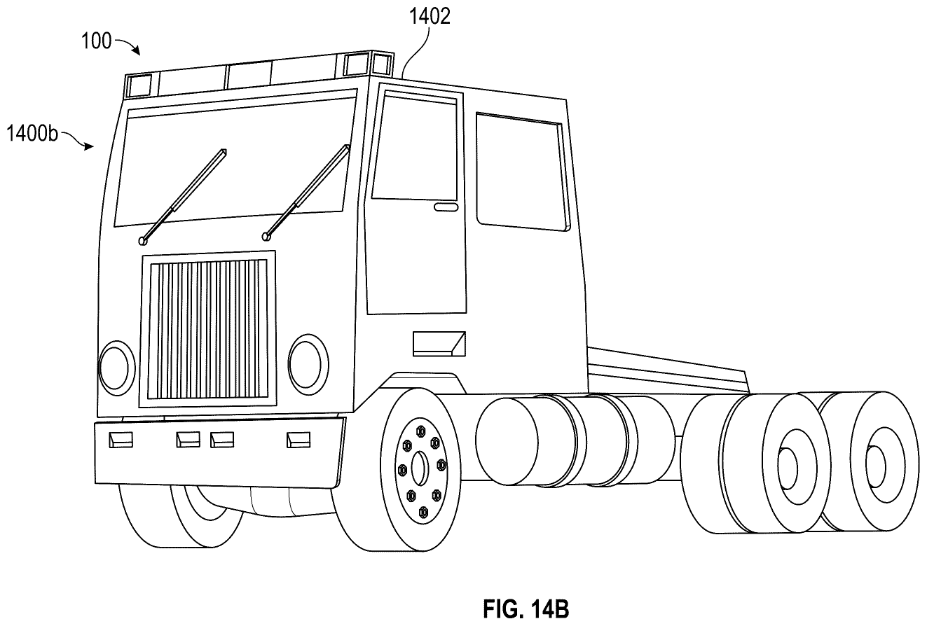

FIG. 1 illustrates a vehicle 10 having a sensor pod assembly 100. The sensor pod assembly 100 is also referred to herein as a sensor pod bar 100 or sensor bar 100. Although a single sensor pod assembly 100 is shown and described, more may be provided. The vehicle 10 may be any motor vehicle, such as, for example, but not limited to a car, a truck, a commercial truck, a bus, a watercraft (e.g., boat, ship, underwater vehicles, etc.), a motorcycle, an aircraft (e.g., airplane, helicopter, etc.), or a spacecraft. For ease of description, the vehicle 10 may be referred to herein as a truck 10. The vehicle 10 may be autonomous or semi-autonomous. In the example of FIG. 1, the vehicle 10 is known in the industry as a sleeper cab, however, as noted, the sensor pod assembly 100 may be coupled to other vehicles (e.g., the trucks of FIGS. 14A and 14B to be discussed later).

With continued reference to FIG. 1, the sensor pod assembly 100 includes a first side sensor pod 102 and a second side sensor pod 104. The sensor pod assembly 100 includes an interior sensor pod 106. Although three sensor pods are shown and described, more or fewer may be provided. For example, multiple interior sensor pods (e.g., like interior sensor pod 106) may be provided and may be spaced between the first side sensor pod 102 and the second side sensor pod 104. In another example, one or both side sensor pods 102, 104 may be included, or both may be omitted. In another example, the interior sensor pod 106 may be omitted. Any combination of sensor pods is contemplated.

The sensor pod assembly 100 may include a frame 110. The frame 110 may be an elongated member or bar extending from a first distal end 110a to a second distal end 110b. Each sensor pod 102, 104, 106 may be connected, attached, or otherwise coupled to the frame 110. In the example of FIG. 1, the first side sensor pod 102 is coupled to the first distal end 110a of the frame 110 and the second side sensor pod 104 is coupled to the second distal end 110b of the frame 110. The interior sensor pod 106 is coupled to an interior portion 110c of the frame 110. Although shown in the center of the frame 110, the interior sensor pod 106 may be coupled along the interior portion 110c of the frame 110 at any point between the first distal end 110a and the second distal end 110b.

The frame 110 is also referred to herein as a bar 110. The frame 110 is external to the vehicle 10. A portion (not visible) of the frame 110 is connected to a portion of the vehicle 10. The connection between the frame 110 and the vehicle 10 may be permanent (e.g., welded, molded, adhered, etc.) or removable (e.g., bolted or fastened). In some examples, the frame 110 and the vehicle 10 are connected with adhesive, welding, fasteners, or are formed together through casting or molding or the like. The frame 110 may be integral with the vehicle 10. As shown in FIG. 1, the frame 110 is attached to the vehicle 10 in a location that is above a windshield 12 of the vehicle 10. The area 14 above the windshield 12 of the vehicle 10 is also referred to as a roof fairing or a cowling. Thus, the frame 110 may be connected to the roof fairing or the cowling. The location of the frame 11 may be selected such that the sensor pods mounted or connected to the frame 11 have a predetermined field of view. For example, the frame 11 may be mounted such that the combined field of view of all of the sensor pods (e.g., sensor pods 102, 104, 106) is 360 degrees. In another example, the frame 11 may be mounted such that the combined filed of view of all of the sensor pods extends from a first lateral side 16 of the vehicle 10 (or of a trailer coupled to the vehicle 10) to a second lateral side 18 of the vehicle 10 (or of the trailer coupled to the vehicle 10).

The sensor pods 102, 104, 106 and frame 110 are schematic and a person of ordinary skill in the art will understand that the shape and sizing of the sensor pods 102, 104, 106 and frame 110 may be any shape or size that allows for coupling to the vehicle 10 in a manner in accordance with the present disclosure. The sensor pods 102, 104, 106 may assist in navigation of the vehicle 10. In some examples, the sensor pods 102, 104, 106 may assist in navigation in a manner that results in the vehicle 10 being an autonomous or self-driving vehicle. In this regard, the sensor pods 102, 104, 106 may include, for example, but not limited to, one or more cameras, one or more lidars, one or more radars, one or more inertial measurement units, one or more mirrors, one or more of any sensor type that may be useful for the operation of the vehicle, or any combination thereof. The vehicle 10 may use (via a processor or controller) data collected by one or all of the sensor pods 102, 104, 106 to navigate the vehicle 10 and to control the speed, direction, braking, and other functions of the vehicle 10. By way of example, any or all of the sensor pods 102, 104, 106 may be any of the sensor pods shown and described in International Patent Application No. WO 2020/180707 or U.S. patent application Ser. No. 17/826,000, the contents of each of which are herein incorporated by reference in their entirety. The combination of sensors may be fixed relative to one another within the sensor pods 102, 104, 106 and a local reference frame for some or all of the sensors in the sensor pod 102, 104, 106 may be generated with respect to the vehicle.

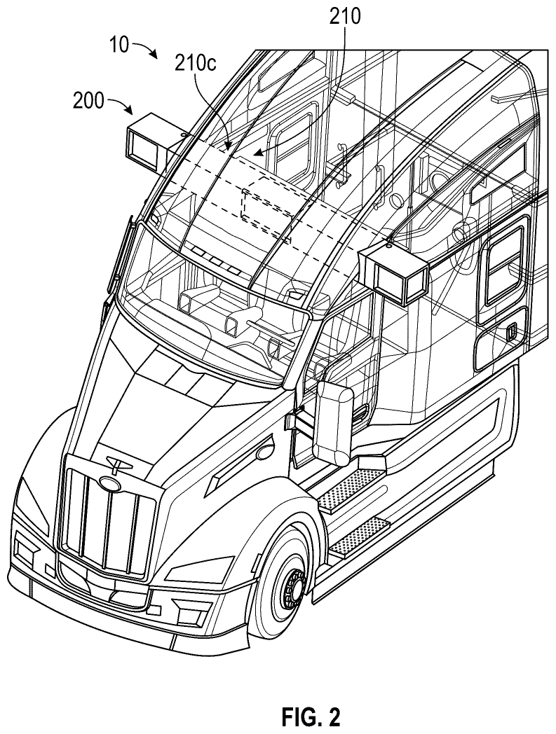

FIG. 2 illustrates the vehicle 10 with a sensor pod assembly 200. The sensor pod assembly 200 may be the same as or similar to the sensor pod assembly 100. The difference between the sensor pod assembly 100 and the sensor pod assembly 200 is that an interior portion 210c of a frame 210 of the sensor pod assembly 200 is interior to the vehicle 10. In contrast, the frame 110 of the sensor pod assembly 100 is exterior to the vehicle 10. Any or all of the locations, characteristics, features, sensor pods, frame features, or orientations, etc. described with respect to the sensor pod assembly 100 may be included in the sensor pod assembly 200. The vehicle 10 of FIG. 2 is illustrated as “see-through” to facilitate understanding of the interior location of the frame 210.

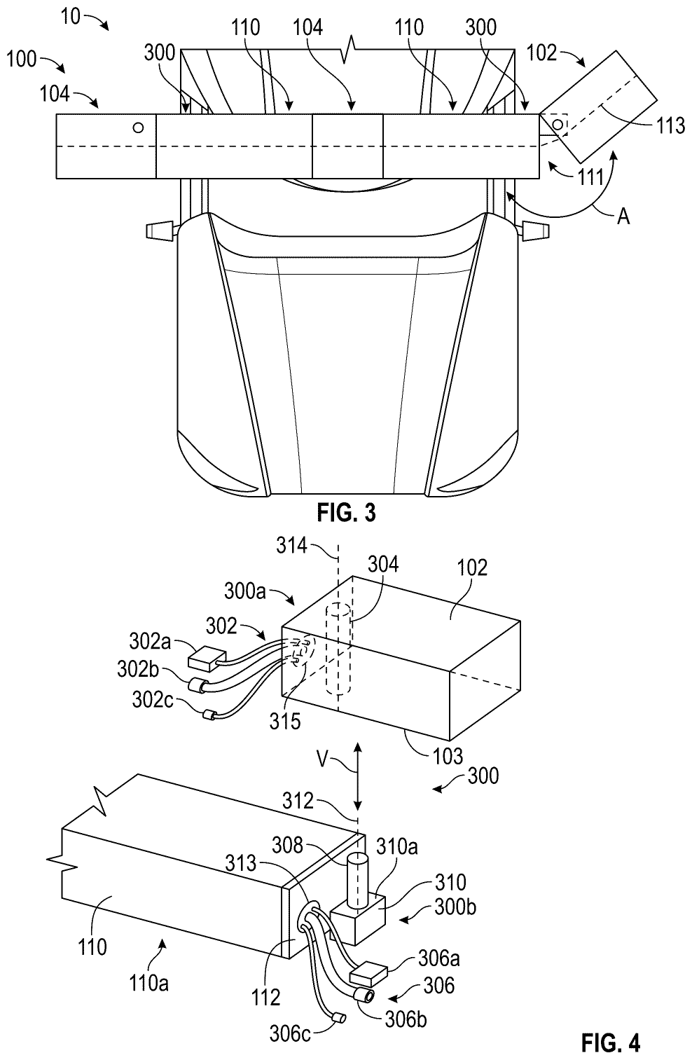

FIG. 3 illustrates a top view of the vehicle 10 and sensor pod assembly 100. It is understood that a top view of the vehicle 10 and the sensor pod assembly 200 may appear the same as or similar to the view of FIG. 3. Thus, for the sake of ease of description, FIG. 3 is described with respect to sensor pod assembly 100, but is understood to be applicable to sensor pod assembly 200 as well. The first side sensor pod 102 is coupled to the frame 110 with a connecting assembly 300. The connecting assembly 300 allows the first side sensor pod 102 to rotate in the direction A between a misaligned position (e.g., as shown in FIG. 3) and an aligned position (e.g., as shown in FIG. 1). In the misaligned position of FIG. 3, a longitudinal, axial centerline axis 111 of the frame 110 is at an angle with respect to a longitudinal, axial centerline axis 113 of the first side sensor pod 102. In the aligned position of FIG. 1, the longitudinal, axial centerline axes 111, 113 are parallel and collinear.

The second side sensor pod 104 is connected to the frame with another connecting assembly 300 that is the same as the connecting assembly 300 connecting the first side sensor pod 102 to the frame 110. In some examples, the connecting assemblies may be different for the first side sensor pod 102 and the second side sensor pod 104. In some examples, the connecting assembly 300 may be the same as or similar to any of the connecting assemblies described in U.S. patent application Ser. No. 17/826,000, herein incorporated by reference in its entirety. For example, the post, socket, conduits, sensor pods, etc., may be the same as the bracket pin, pin receiving opening, conduits, and sensor pods, respectively, of U.S. patent application Ser. No. 17/826,000, and, thus, the related features, structures, and arrangements may also be provided in the connecting assembly 300 (e.g., the thrust bearing, flanges, etc.)

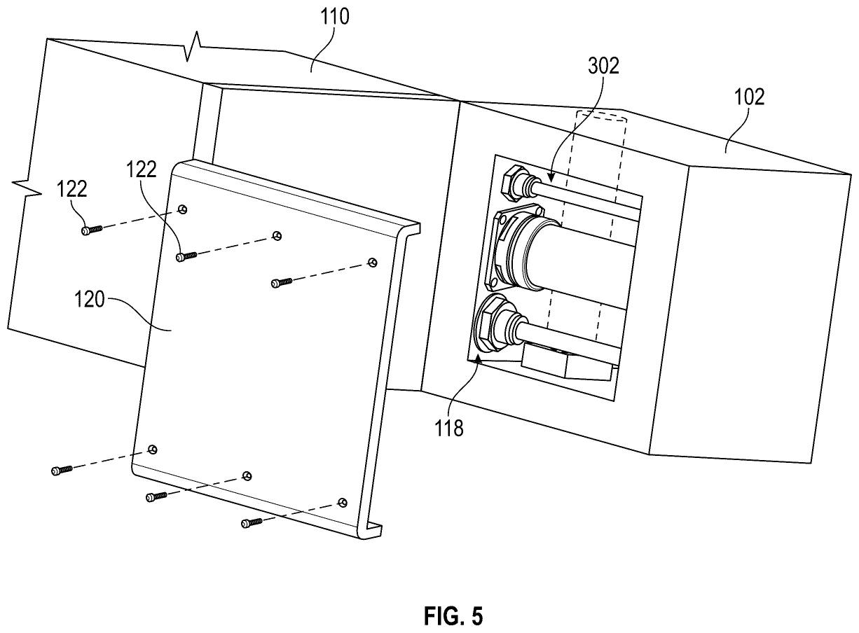

FIG. 4 illustrates the connecting assembly 300 between the first side sensor pod 102 and the frame 110. The vehicle 10 is omitted for clarity. Again, as noted, the frame 110 and the first side sensor pod 102 are illustrated schematically and their shape is understood to not be limited to the rectangular shape shown. Instead, as mentioned, the sensor pod includes sensors, windows, screens, etc., as need to facilitate autonomous or semi-autonomous navigation of the vehicle 10 (FIG. 1). Although shown in relation to first side sensor pod 102, the connecting assembly 300 of FIG. 4 may be applied to the second side sensor pod 104 in a mirror arrangement to that which is shown.

Referring to FIG. 4, the connecting assembly 300 includes a sensor pod portion 300a and a frame portion 300b. The sensor pod portion 300a includes one or more conduits 302 (three shown, more or fewer may be provided) and a socket 304. The frame portion 300b includes one or more conduits 306 (three shown, more or fewer may be provided) and a post 308. The post 308 is also referred to herein as an axle 308, pin 308, or protrusion 308. The post 308 may extend from a ledge 310 coupled to a distal side surface 112 of the first distal end 110a of the frame 110. As noted, more or fewer conduits 302, 306 may be provided, however, it is understood that the same number conduits will be provided on the sensor pod portion 300a and the frame portion 300b. In the example shown in FIG. 3, the one or more conduits 302 includes a power/data/communication conduit 302a, an air conduit 302b, and a water conduit 302c. Likewise, the one or more conduits 306 include a complementary power/data/communication conduit 306a, air conduit 306b, and water conduit 306c. The frame 110 includes an opening 313 through which the one or more conduits 306 may extend. In this manner, the one or more conduits 306 may extend through the frame 110 to be coupled to a computer of the vehicle 10 (FIG. 1). An opening 315 may be included in the first side sensor pod 102 to allow passage of the one or more conduits 302.

The post 308 is formed of a material having a strength and durability to support the load of the sensor pod 102 and to avoid or reduce pitting or scratching on the post 308 that may otherwise inhibit rotation of the sensor pod 102 about the post 308. In some examples, the post 308 may, thus, be formed of a different material than the frame 110, where the material of the post 308 is harder than the material of the frame 110. In some examples, the post 308 may be formed unitarily or integrally with the ledge 310. In some examples, to facilitate manufacturing the post 308 of a different material, the post 308 may be formed separately and coupled to the ledge 310.

The post 308 provides a support axle extending from the frame 110. The length of the support axle (e.g., the length of the post 308) and the depth of the socket 304 are sized (e.g., sized in length and diameter) to counteract the moment created by the weight of the sensor pod 102. This may allow for the sensor pod 102 to be easily, quickly, and efficiently installed and uninstalled. In some examples, this may be possible by a single operator. This is due to the load bearing hook that the post 308 provides, allowing a single person to lower the sensor pod 102 onto the post 308 which is already secured to the vehicle 10.

To connect the first side sensor pod 102 to the frame 110, the first side sensor pod 102 may be lowered in the vertical direction V toward the frame 110. The socket 304 is aligned with the post 308. The first side sensor pod 102 is lowered until the post 308 is received within the socket 304 and a lower surface 103 of the first side sensor pod 102 is resting on an upper surface 310a of the ledge 310. Once the post 308 is received in the socket 304, a longitudinal, axial centerline axis 312 of the post 308 is coaxial and coincident with a longitudinal, axial centerline axis 314 of the socket 304. Once the post 308 is received in the socket 304, the two features operate as a hinge between the first side sensor pod 102 and the frame 110 allowing for the rotational movement in the direction A (FIG. 3) about the longitudinal, axial coaxial centerlines 312, 314. Once the post 308 is received in the socket 304, the conduits 302 and 306 may be connected, prior to rotating the first side sensor pod 102 into alignment with the frame 110. After alignment, and although not illustrated in FIG. 4, fasteners may be provided to maintain the first side sensor pod 102 in the aligned position with the frame 110 (e.g., as shown in FIG. 1).

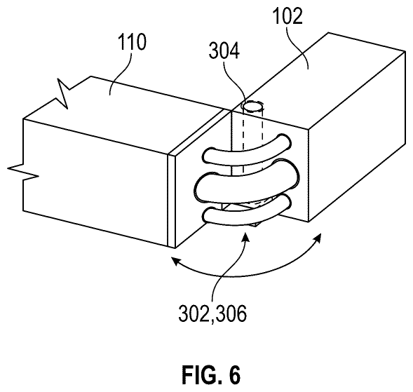

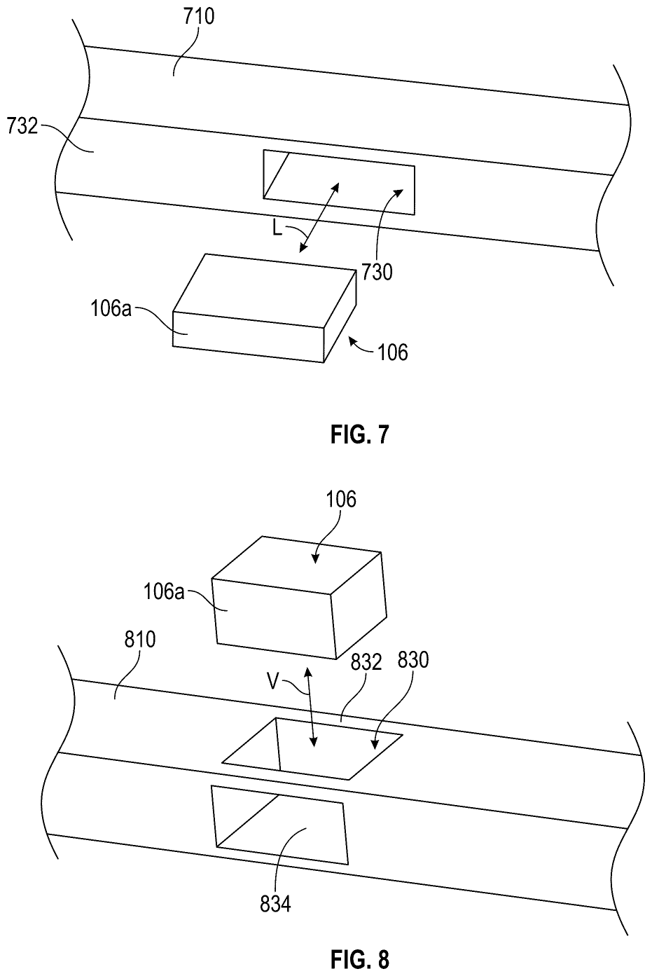

In FIG. 4, the one or more conduits 302 and 306 may mate or connect within a body of the sensor pod 102 or the frame 110 such that the one or more conduits 302 and 306 are concealed within the sensor pod 102 or the frame 110. FIG. 5 illustrates an exemplary arrangement where the one or more conduits 302 are housed within a cavity 118 in the sensor pod 102 and are concealed with a cover 120 coupled to the first side sensor pod 102 with a plurality of fasteners 122. In some examples, a similar cavity and cover may be provided on the frame 110, in lieu of or in addition to the cavity 118 and cover 120 of the first side sensor pod 102. FIG. 6 illustrates the step in the installation process wherein the post 308 (FIG. 4) is received within the socket 304 and the conduits 302, 306 are connected. In this position of installation, the first side sensor pod 102 is not yet aligned with the frame 110 as shown in FIG. 1. In FIGS. 5 and 6, the vehicle 10 is omitted for clarity.

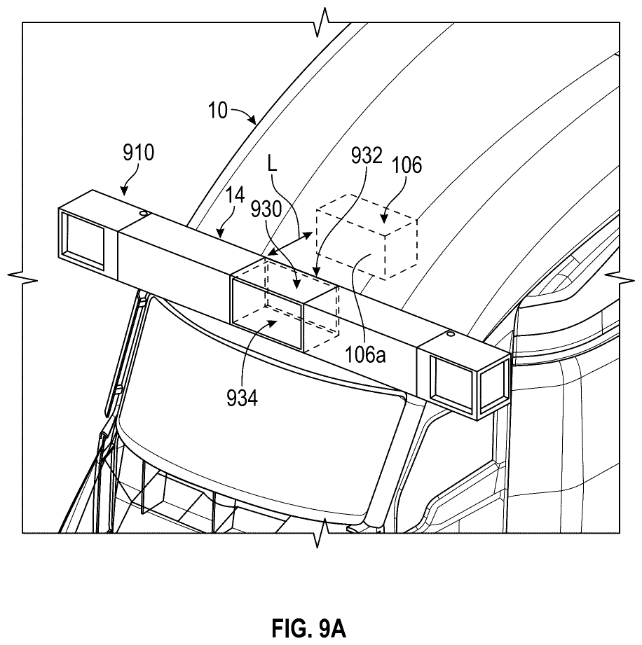

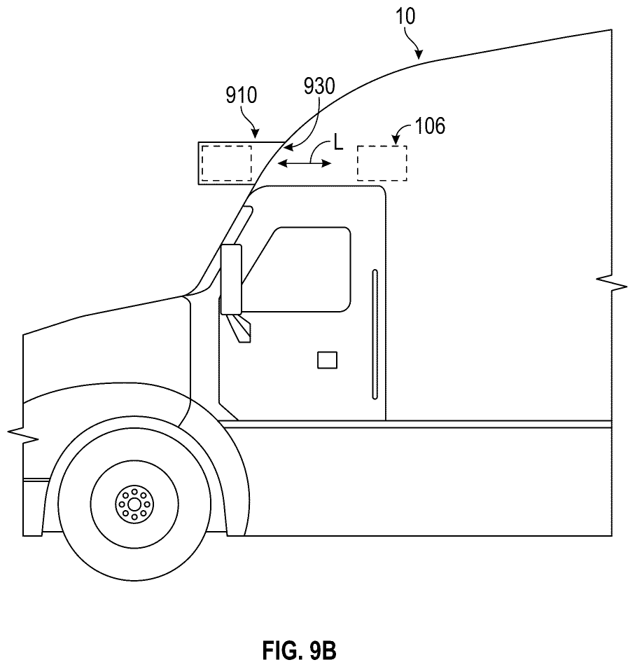

FIGS. 7 to 9B illustrate exemplary connecting assemblies for an interior sensor pod, such as the interior sensor pod 106 of FIG. 1. Any of the interior sensor pod connecting assemblies may be provided with the aforementioned side sensing pod connecting assembly 150. In FIGS. 7 and 8, the vehicle 10 is omitted for clarity.

For example, in FIG. 7, the frame 110 of FIG. 1 may be a frame 710 that includes an opening 730 in a forward surface 732 of the frame 710. The forward surface 732 is the surface of the frame 710 facing a front of the vehicle 10 (FIG. 1). To install, the interior sensor pod 106 is inserted in the lateral direction L from an exterior of the vehicle 10 into the opening 730. Once installed, a forward surface 106a of the interior sensor pod 106 is flush with the forward surface 732 of the frame 710. A latch or lock (not shown) may be provided to maintain the interior sensor pod 106 in the opening 730. The forward surface 106a of the interior sensor pod 106 permits the sensor pod 106 to have a field of view in at least the forward direction with respect to the vehicle 10 (FIG. 1).

In the example of FIG. 8, the frame 110 of FIG. 1 may be a frame 810 that includes an opening 830 in an upper surface 832 of the frame 810. The upper surface 832 is the surface of the frame 810 facing a direction upward and perpendicular to the front of the vehicle 10 (FIG. 1). To install, the interior sensor pod 106 is inserted in the vertical direction V from an exterior of the vehicle 10 into the opening 830. The frame 810 includes a window 834 such that, once installed, the forward surface 106a of the interior sensor pod 106 is permitted to have a field of view in at least the forward direction with respect to the vehicle 10 (FIG. 1). A latch or lock (not shown) may be provided to maintain the interior sensor pod 106 in the opening 830.

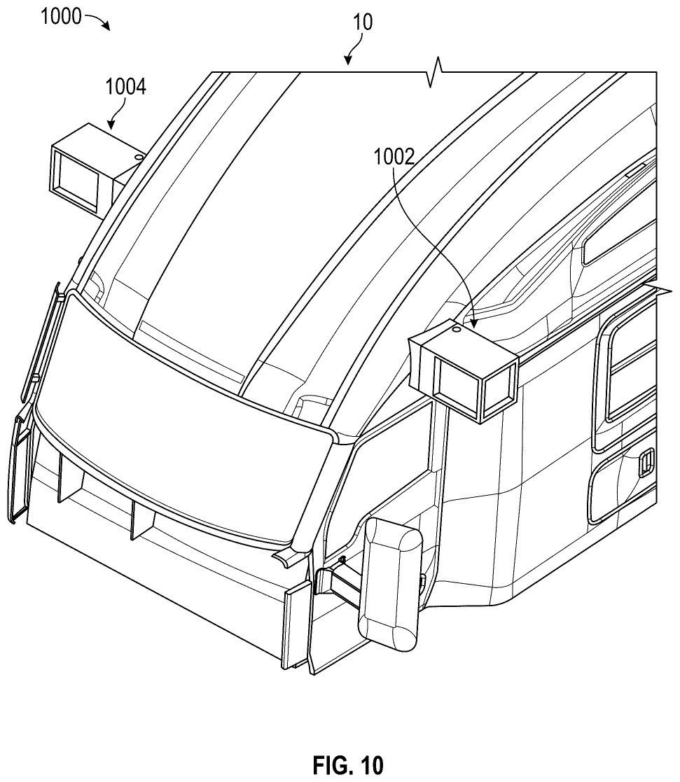

In the example of FIGS. 9A and 9B, the frame 110 of FIG. 1 may be a frame 910 that includes an opening 930 in a rear surface 932 of the frame 910. The rear surface 932 is the surface of the frame 910 facing a direction to the rear of the vehicle 10 (FIG. 1). Due to the location of the frame 910 in the area 14 (as discussed with respect to FIG. 1), the opening 930 is not accessible from an exterior of the vehicle 10. Therefore, a complementary opening (not visible) is provided in the area 14 of the vehicle 10 aligned with the opening 930 of the frame 910. To install, the interior sensor pod 106 is inserted in the lateral direction L into the opening 930 from an interior of the vehicle 10. The frame 910 includes a window 934 such that, once installed, the forward surface 106a of the interior sensor pod 106 is permitted to have a field of view in at least the forward direction with respect to the vehicle 10. A latch or lock (not shown) may be provided to maintain the interior sensor pod 106 in the opening 930.

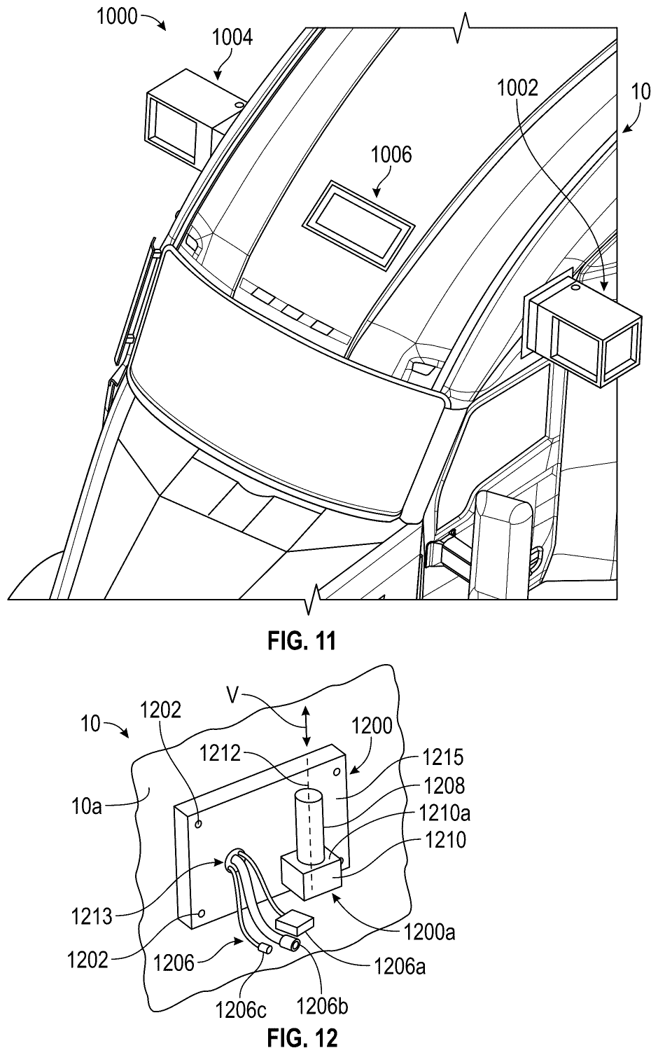

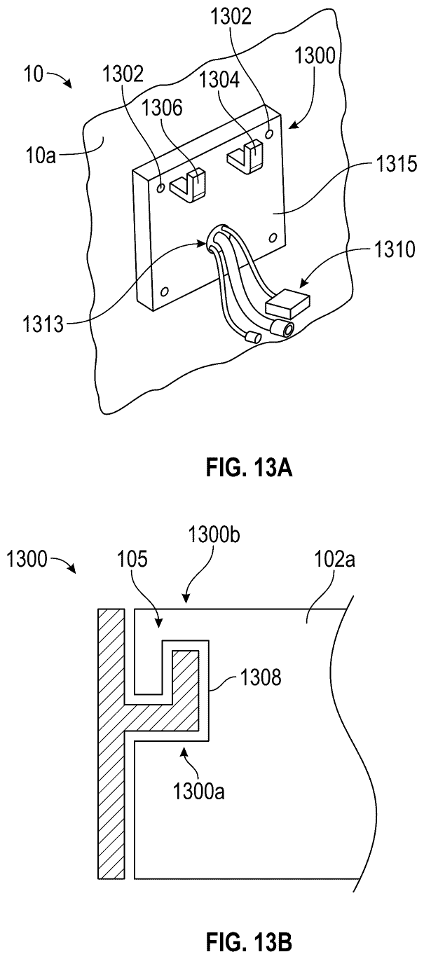

FIGS. 10 and 11 illustrate an exemplary sensor pod assembly 1000 that includes brackets in place of the frame or bar of FIGS. 1 to 9B. Although the frame is not employed in FIGS. 10 and 11, the sensor pods may be the same or similar to any of the prior described sensor pods and any or all of the locations, characteristics, features, sensor pods, or orientations, etc. described with respect to the prior sensor pod assemblies may be included in the sensor pod assembly 1000. FIGS. 10 and 11 illustrate a sensor pod assembly 1000 installed on the vehicle 10. The sensor pod assembly 1000 includes a first side sensor pod 1002 and a second side sensor pod 1004. One or more interior sensor pods 1006 are optional (e.g., the interior sensor pod 1006 is included in FIG. 11 and omitted in FIG. 10).

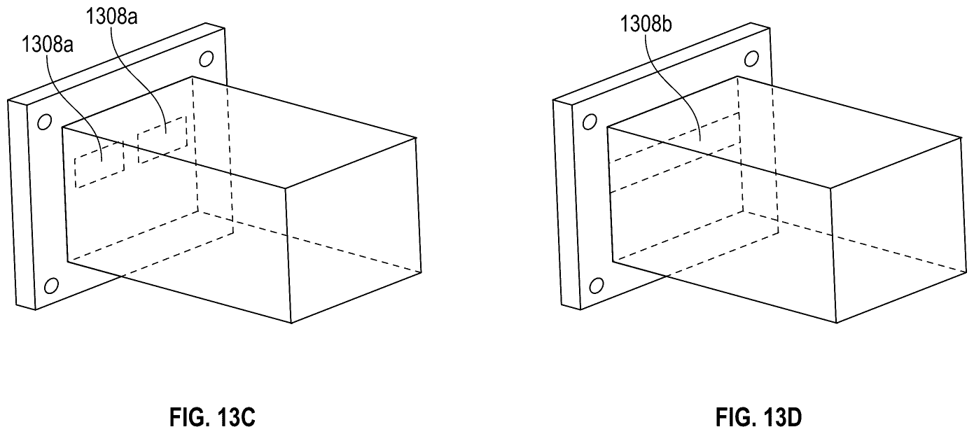

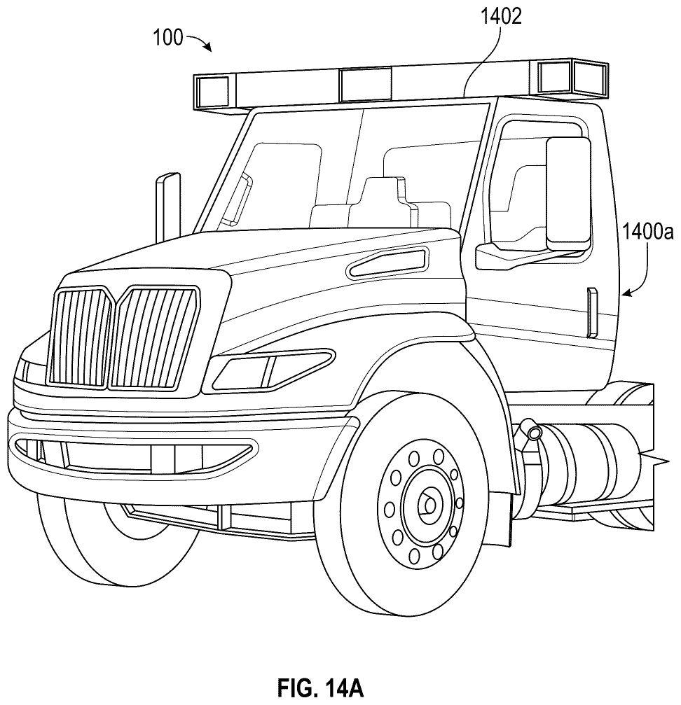

FIGS. 12 to 13D illustrate exemplary brackets that may be employed to connect the first side sensor pod 1002 and/or the second side sensor pod 1004 to the vehicle 10. The vehicle 10 is omitted for clarity. As noted previously, the brackets and sensor pods of FIGS. 10 to 13D are illustrated schematically and their shape is understood to not be limited to the rectangular shape shown. Instead, the sensor pod includes sensors, windows, screens, etc., as need to facilitate autonomous or semi-autonomous navigation of the vehicle 10. Although the connecting assemblies of FIGS. 12 to 13D are illustrated on brackets, the connecting assemblies of FIGS. 12 to 13D may be employed with the frame 110 of FIG. 1.

FIG. 12 illustrates a bracket 1200 for connecting a sensor pod to the vehicle 10. The bracket 1200 may be permanently attached (e.g., welded, molded, adhered, etc.) or removably attached (e.g., bolted or fastened with one or more fasteners 1202) to a surface 10a of the vehicle 10. The bracket 1200 may be integral with the vehicle 10. In some examples, the bracket 1200 and the vehicle 10 are connected with adhesive, welding, fasteners, or are formed together through casting or molding or the like. The features of the bracket 1200 may be the same as or similar to the frame portion 300b on the frame 110 as shown and described with respect to FIG. 4. For example, the bracket 1200 may form a bracket portion 1200a of a connecting assembly and a corresponding sensor pod portion (not shown) may be formed on the sensor pod, in the same manner as described with respect to the sensor pod portion 300a of the sensor pod 102 in FIG. 4.

The bracket portion 1200a includes one or more conduits 1206 (three shown, more or fewer may be provided) and a post 1208. The post 1208 is also referred to herein as an axle 1208, pin 1208, or protrusion 1208. The post 1208 may extend from a ledge 1210 coupled to a distal side surface 1215 of the bracket 1200. As noted, more or fewer conduits 1206 may be provided, however, it is understood that the same number conduits will be provided on the sensor pod portion and the bracket portion 1200a. In the example shown in FIG. 12, the one or more conduits 1206 include a power/data/communication conduit 1206a, an air conduit 1206b, and a water conduit 1206c. The bracket 1200 includes an opening 1213 through which the one or more conduits 1206 may extend. In this manner, the one or more conduits 1206 may extend through the bracket 1200 to be coupled to a computer of the vehicle 10.

The post 1208 may be the same as, or similar to, the post 308, and, thus, the aforementioned features of the post 308 also apply to the post 1208. As shown and described with respect to FIGS. 4 and 12, the post 308 and the post 1208 extend from the frame 110 and bracket 1200, respectively, while the socket 304 extends from the senor pod (e.g., sensor pod 102). In some examples, the arrangement may be reversed, such that the post is located on the sensor pod and the socket is located in the frame or bracket. In either configuration, the post may be unitary with the frame, bracket, or sensor pod or may be removably fixed thereto.

With continued reference to FIGS. 4 and 12, to connect the first side sensor pod 102 (FIG. 4) to the bracket 1200, the first side sensor pod 102 may be lowered in the vertical direction V toward the bracket 1200. The socket 304 is aligned with the post 1208. The first side sensor pod 102 is lowered until the post 1208 is received within the socket 304 and a lower surface 103 of the first side sensor pod 102 is resting on an upper surface 1210a of the ledge 1210. Once the post 1208 is received in the socket 304, a longitudinal centerline axis 1212 of the post 1208 is coaxial and coincident with a longitudinal, axial centerline axis 314 of the socket 304. Once the post 1208 is received in the socket 304, the two features operate as a hinge between the first side sensor pod 102 and the bracket 1200 allowing for the rotational movement in the direction A (FIG. 3) about the coaxial longitudinal, axial centerlines 1212, 314. Once the post 1208 is received in the socket 304, the conduits 1206 and 306 may be connected, prior to rotating the first side sensor pod 102 into alignment with the bracket 1200. After alignment, and although not illustrated in FIG. 12, fasteners may be provided to maintain the first side sensor pod 102 in the aligned position with the bracket 1200 (e.g., as shown in FIG. 11).

FIGS. 13A to 13D illustrates a bracket 1300 for connecting a sensor pod 102a to the vehicle 10. The bracket 1300 may be permanently attached (e.g., welded) or removably attached (e.g., bolted or fastened with one or more fasteners 1302) to a surface 10a of the vehicle 10. In some examples, the bracket 1300 and the vehicle 10 are connected with adhesive, welding, fasteners, or are formed together through casting or molding or the like. The bracket 1300 may form a bracket portion 1300a of a connecting assembly and a corresponding sensor pod portion 1300b (not shown) of the connecting assembly may be formed on the sensor pod.

As shown in FIGS. 13A and 13B, the bracket 1300 includes a first hook 1304 and a second hook 1306 extending from a distal end surface 1315 of the bracket 1300. Although two hooks are shown, more or fewer may be provided. The hooks 1304, 1306 are received in an opening 1308 formed on a distal end 105 of the first side sensor pod 102a. An opening 1313 is formed in the distal end surface 1315 to allow passage of the one or more conduits 1310 from the vehicle computer to the first side sensor pod 102a. As in prior examples, complementary conduits (not visible) are provided on the first side sensor pod 102a.

FIGS. 13C and 13D illustrate two exemplary orientations of the opening 1308 of the first side sensor pod 102a of FIG. 13B. In FIG. 13C, the opening 1308 may be two openings 1308a to correspond to the first hook 1304 and the second hook 1306. In examples where more hooks are provided, more openings may be provided as well. In FIG. 13D, the opening 1308 may be a slot 1308b that can slide over the one or more hooks (e.g., the first hook 1304 and the second hook 1306). Once the hooks are received in the openings, one or more fasteners (not illustrated) may secure the sensor pod to the bracket to maintain the first side sensor pod 102 in the aligned position with the bracket 1300 (e.g., as shown in FIG. 10).

FIGS. 14A and 14B illustrate alternative vehicles 10 that may include the sensor pod assemblies of the present disclosure. Although FIGS. 14A and 14B illustrate the sensor pod assembly having a frame, the sensor pod assemblies having brackets as described with respect to FIGS. 10 to 13D may be provided on the vehicles of FIGS. 14A and 14B. FIG. 14A illustrates a vehicle 1400a that is conventionally known as a day cab truck. The vehicle 1400a includes a different configuration of the roof and, thus, the sensor pod assembly 100 may be coupled to an upper surface 1402 of the roof of the vehicle 1400a. FIG. 14B illustrates a vehicle 1400b that is conventionally known as a cab-over truck. The vehicle 1400b includes a different configuration of the roof and, thus, the sensor pod assembly 100 may be coupled to an upper surface 1402 of the roof of the vehicle 1400b.

As noted, the one or more sensor pods include one or more conduits that are complementary to one or more conduits extending from the vehicle 10 (either through the frame or through the bracket). The one or more conduits may bring power, water, air, data, electricity, other fluids, or the like from the vehicle 10 (FIG. 1), through the frame (e.g., frame 110) or bracket (e.g., bracket 1200) to the sensor pod (e.g., sensor pods 102, 104, 106). The one or more conduits may allow the sensor pod to receive and transmit (e.g., may have two-way communication) data, power, information, signals (e.g., control signals) with the vehicle 10. Cleaning fluids, such as water and air, may also be provided to the sensor pod for cleaning the sensors housed within.

The connection between the post and the socket allows for relative rotation of the sensor pod with respect to the frame or bracket. The ledge on which the post is formed allows for the weight of the sensor pod to be supported by the frame or bracket. Thus, connecting assemblies of the present disclosure allow relative rotation while also supporting the axial load caused by the weight of the sensor pod.

The connecting assemblies of the present disclosure provide a rigid (i.e., little, minimal or no relative movement) between the sensor pods and the vehicle. The rigidness resulting from the limiting or preventing of relative movement provides an anti-vibration system for the sensor pod which, may reduce, limit, or prevent the negative impacts that vibration may cause on the sensor and/or the calibration of the sensors.

The connecting assemblies of the present disclosure support the weight of the sensor pods during installation of the sensor pod (prior to securing) and once installed and secured. This allows a single operator to install and uninstall the sensor pod from the vehicle. That is, during installation, the operator may install the sensor pod portion of the connecting assembly on the vehicle portion of the connecting assembly. In this condition, the vehicle portion of the connecting assembly supports the weight of the sensor pod, but the sensor pod is not yet fully installed and is not yet fully secured to the vehicle portion of the connecting assembly. In this condition, with the vehicle portion of the connecting assembly supporting the weight of the sensor pod, the operator may release the sensor pod such that the operator (or any installation equipment) is not supporting the sensor pod. That is, the sensor pod is only supported by the vehicle portion of the connecting assembly. Then, the operator may secure the sensor pod to the vehicle portion of the connecting assembly. For example, the operator may install fasteners, latches, locks, etc., that prevent the sensor pod from detaching from the vehicle portion of the connecting assembly. Since the connecting assembly supports the weight of the sensor pod, the operator does not need to support the sensor pod while attempting to secure the sensor pod to the vehicle. The operator can allow the connecting assembly to support the sensor pod while securing the sensor pod to the vehicle portion of the connecting assembly. When the sensor pod is to be removed (for recalibration, repair, replacement, etc.), the operator may unsecure the sensor pod from the vehicle portion, at which point, the vehicle portion continues to support the sensor pod until the operator removes the sensor pod from the vehicle portion of the connecting assembly.

For example, referring to FIG. 4, the sensor pod 102 is placed on the vehicle portion 300b such that the post 308 is received within the socket 304. At that point, the vehicle portion 300b is supporting the weight of the sensor pod 102, but the sensor pod 102 is not yet fully installed since relative rotation between the sensor pod 102 and the frame 110 is still permitted in the direction of A (FIG. 3). Once the sensor pod 102 is rotated into alignment with the frame 110 (as shown in FIG. 1), then the sensor pod 102 is secured to the frame 110 such that such relative rotation is not permitted and the alignment shown in FIG. 1 is maintained in the secured position. Likewise, the sensor pod 106 is supported by the frame 110 (FIG. 7) once inserted into the opening 730, but prior to securing within the opening 730 (e.g., via a lock or latch or fastener). Similarly, the hooks 1304, 1306 of FIG. 13A also support the weight of the sensor pods before securing of the sensor pods to the bracket 1300. Therefore, the connecting assembly supports the weight of the sensor pod during installation of the sensor pod and prior to securing of the sensor pod to the frame or bracket.

As described herein, the portion of the connecting assembly attached to the vehicle (e.g., the frame, the post/ledge, the hooks, the bracket, etc.) is considered the vehicle portion of the connecting assembly, while the portion of the connecting assembly attached to the sensor pod (e.g., the socket and openings, etc.) is considered the sensor pod portion. In the case of the interior sensor pods, the opening is considered the vehicle portion and the sensor pod body is considered the sensor pod portion.

Any of the aforementioned connecting assemblies, or portions thereof, may be combined with other connecting assemblies without departing from the scope of the present disclosure.

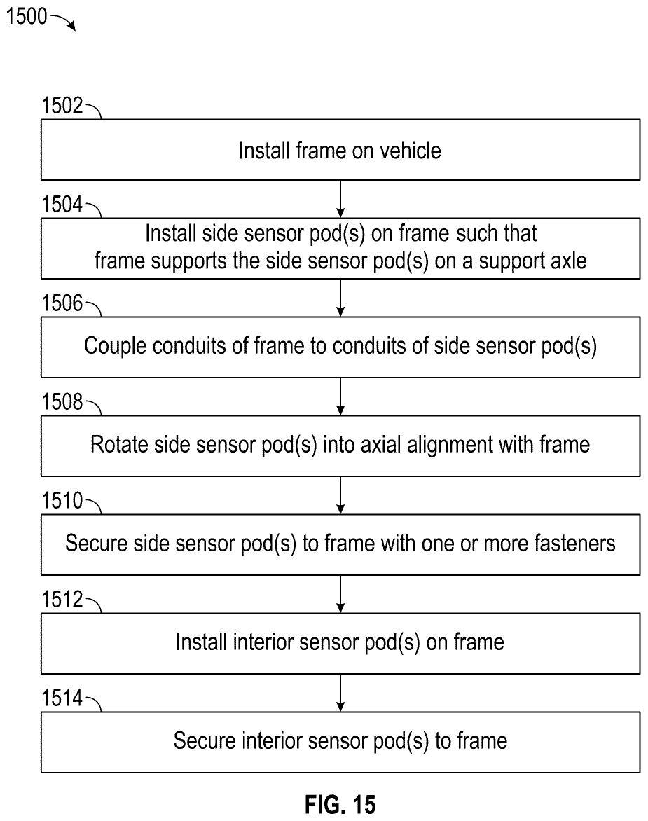

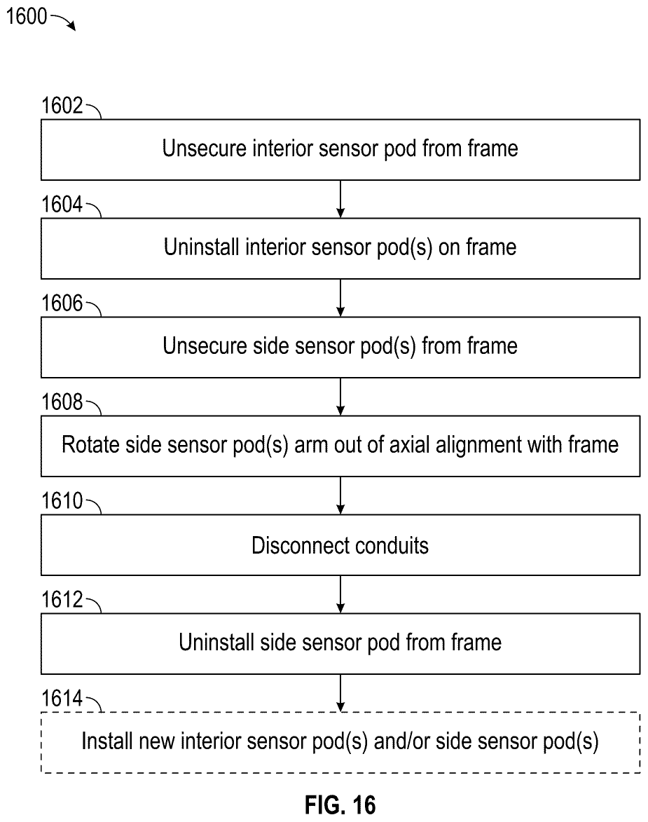

Referring to FIGS. 15 and 16, the methods of installing and uninstalling the sensor pods are described, respectively. To install the sensor pod (e.g., sensor pods 102, 104, 106) on the vehicle 10 refers to the method or process of physically connecting the sensor pod to the vehicle 10 by way of the connecting assembly and physically connecting the one or more conduits extending from the vehicle 10 to the sensor pod. To uninstall or remove the sensor pod from the vehicle 10 refers to the method or process of physically removing the sensor pod from the vehicle 10 and physically disconnecting the one or more conduits from the sensor pod.

Briefly, to install the sensor pods 102, 104 on the vehicle 10, the sensor pod is located over the support axle (e.g., post 308) such that the socket (e.g., socket 304) is aligned with the support axle. The sensor pod is then lowered onto the support axle. Once lowered on, the support axle supports the weight of the sensor pod in a manner that prevents the weight of the sensor pod from causing the sensor pod to fall once an operator is no longer supporting the sensor pod. The conduits are connected to the corresponding conduits. Once the conduits are connected, the sensor pod is rotated into alignment with the frame or bracket and secured (e.g., with fasteners. The connecting assembly, and in particular the support axle, allows for a single operator to install the sensor pods 102, 104 even given the weight of the sensor pod (e.g., the sensor pod has significant weight due to the sensors and components therein, heavier than a conventional sideview mirror). To install the interior sensor pod 106, the operator inserts the sensor pod into the opening in the frame or vehicle. If provided, a latch or lock is secured to secure the sensor pod in the opening.

FIG. 15 illustrates a method to install the sensor pods on a vehicle roof. At step 1502, the frame 110 is installed on the vehicle 10. In examples where no frame is provided, this step may be omitted. In examples where a bracket is provided in lieu of a frame, the one or more brackets are installed on the vehicle. At step 1504, the side sensor pods (e.g., sensor pods 102, 104) are installed on the frame 110 (or bracket, if appropriate) such that the frame supports the side sensor pods on a support axle. In examples where hooks are provided (e.g., FIG. 13A), the hooks may operate as the support axle, supporting the weight of the sensor pod. At step 1506, the conduits are coupled between the frame and the side sensor pods. At step 1508, the sensor pods are rotated into axial alignment with the frame (or bracket, as appropriate) and, then, at step 1510, the sensor pods are secured to the frame (or bracket, as appropriate). In examples where the bracket or frame includes a hook, at step 1508, the bracket may be slid onto the hooks or rotated downward onto the hooks. At step 1512, the interior sensor pod is inserted into the opening and, at step 1514, secured within the frame. As may be appreciated, the method 1500 is one exemplary method, and the sensor pods may be installed in any order (e.g., interior before side) or may be installed simultaneously by multiple operators (e.g., one operator per sensor pod).

FIG. 16 illustrates a method 1600 to uninstall the sensor pods on a vehicle roof. At step 1602, the interior sensor pod is unsecured from the frame, bracket, or roof, and, at step 1604, the interior sensor pod is removed from the frame, bracket, or roof. At step 1606, the side sensor pods are unsecured from the frame or bracket, and, at step 1608, the side sensor pods are rotated out of alignment with the frame or bracket. In examples where the bracket or frame includes a hook, the bracket may be slid off or rotated upward off of the hooks. At step 1610, the conduits are disconnected from the vehicle and, at step 1612, the side sensor pods are removed from the frame or brackets. If required, new or replacement sensor pods may be installed at step 1614 according to the method 1600. As with the method 1500, the sensor pods may be installed in any order or may be installed simultaneously by multiple operators.

Accordingly, the connecting assemblies of the foregoing description provides a rigid and stable connection between the vehicle and the sensor pods. The terms “rigid” and “stable” indicate that there is no relative motion between the sensor pods and the vehicle when the sensor pod is affixed to the vehicle with the connecting assemblies. Thus, during operation of the vehicle, the sensor pod will move in the same direction of travel as the vehicle. Such a rigid and stable connection allows for the sensor pod to gather data and assist in navigation of the vehicle with reduced or eliminated noise that is associated with relative motion of the sensor pod with respect to the vehicle. The rigid connection provided by the connecting assembly provides an anti-vibration system which results in the reduced or eliminated noise as there is minimal or no resonant vibration due to the sensor pod moving with the vehicle. That is, the connecting assembly prevents or limits vibration of the sensor pod with respect to the vehicle through the rigid connection of the connecting assembly. Reduction or prevention of vibration of the sensor pod is important for the proper function of the sensor pod and the sensors therein, which in turn is important to the proper operation of the vehicle. Vibration of the sensor pod caused by an improperly or non-rigidly secured sensor pod may affect the accuracy and precision of the sensors, which negatively impacts the operation of the sensor pod and the vehicle.

Furthermore, due to the removable connection between the sensor pod and the bracket or frame, the sensor pod may be removed for replacement, repair, evaluation, etc. A new, different sensor pod may be installed on the bracket or frame and/or the original sensor pod, once repaired, updated, or confirmed to be operational, may be installed on the bracket or frame. Accordingly, the connecting assembly provides a rigid connection and a removable connection.

Accordingly, the sensor pod of the present disclosure may be a quick swap sensor pod. That is, due to the connecting assembly, the sensor pod may be removed and installed on a vehicle in a quick manner by a single operator. In some examples, the sensor pod as a quick swap sensor pod includes a support axle. The support axle is formed to support the weight of the quick swap sensor pod before installation is complete (e.g., at a step of installation when the sensor pod is coupled to the bracket or frame, but before the rigid connection is formed with the fasteners). The support axle may be formed with a depth, length, diameters, width, material, or combinations thereof to accomplish the support of the weight of the sensor pod. The support axle may also counteract a moment created by the weight of the sensor pod acting on the connecting assembly. That is, the weight of the sensor pod will provide a vertically downward force acting to rotate or bend the connecting assembly vertically downward. The support axle may counteract this bending moment, further achieving the aforementioned rigid connection which limits or prevents relative movement between the sensor pod and the vehicle. In some examples, the support axle is a post or hooks.

With the above configurations, the quick swap sensor pod may be installed and removed a plurality of times. The quick swap sensor pod may have a common arm that interacts with the bracket arm but may have a housing with different configurations of mirrors, sensors, or the like. In this manner, the quick swap sensor pod may be interchangeable with other quick swap sensor pods of the same or different configurations. Furthermore, in the event the quick swap sensor pod is needed to be removed due to damage, need for repair, need for calibration, software updating, hardware updating, etc., the quick swap sensor pod may be removed and reinstalled or removed and replaced with another quick swap sensor pod.

The connecting assembly, frame, or brackets, or any part or combination of parts thereof, may be formed of metal, such as, for example, aluminum, composites, such as, for example, fiber glass, carbon fiber, or other known materials, or combinations thereof. The connecting assembly, frame, or brackets, or any part or combination of parts thereof, may be formed by casting, machining, molding, or other known manufacturing methods, or combinations thereof. The post may be formed of a chrome plated hardened steel or other known materials for providing a bearing surface.

The connecting assembly of the present disclosure further allows for a quick swap sensor pod and a universal bracket or universal frame such that a multitude of sensor pods may be interchanged on the vehicle quickly and efficiently. The connecting assembly may allow for a rigid connection during operation that operates as an anti-vibration system to reduce extraneous vibration and noise to the sensor pod. The structure of the connecting assembly may support the weight of the sensor pod and counteract the moment acting on the connecting assembly by the weight of the sensor pod.

Further aspects of the present disclosure are provided by the subject matter of the following clauses.

A roof mounted sensor pod assembly for a vehicle having a frame configured to attach to the vehicle, a connecting assembly located on the frame and a sensor pod configured to couple to the connecting assembly. The connecting assembly is configured to support the weight of the sensor pod during installation of the sensor pod and prior to securing of the sensor pod to the frame.

The roof mounted sensor pod assembly the preceding clause, wherein the frame haves a first distal end and a second distal end, and wherein the connecting assembly is located at the first distal end or the second distal end.

The roof mounted sensor pod assembly of any preceding clause, wherein the frame haves a first distal end and a second distal end, and wherein the connecting assembly is a first connecting assembly and the sensor pod is a first side sensor pod connected to a the first distal end of the frame, the roof mounted sensor pod assembly further having a second connecting assembly located at the second distal end of the frame and a second side sensor pod configured to couple to the second distal end of the frame with the second connecting assembly.

The roof mounted sensor pod assembly of any preceding clause, wherein each of the sensor pod and the frame has a longitudinal, centerline axis, and wherein the sensor pod has a first position where the longitudinal, centerline axes are misaligned and a second position where the longitudinal, centerline axes are aligned and coaxial.

The roof mounted sensor pod assembly of any preceding clause, wherein the sensor pod is configured to rotate between an uninstalled position and an installed position.

The roof mounted sensor pod assembly of any preceding clause, wherein the connecting assembly haves a post located on one of the frame and the sensor pod and a socket located on the other of the frame and the sensor pod. The socket is configured to receive the post to connect the sensor pod to the frame.

The roof mounted sensor pod assembly of any preceding clause, wherein the post extends vertically upward from a ledge on the frame, the post and ledge configured to support the weight of the sensor pod when received within the socket.

The roof mounted sensor pod assembly of any preceding clause, wherein the post and the socket are configured to operate as an axle to allow rotation of the sensor pod with respect to the frame.

The roof mounted sensor pod assembly of any preceding clause, the sensor pod further having one or more conduits configured to couple to the vehicle.

The roof mounted sensor pod assembly of any preceding clause, wherein the frame haves a first distal end and a second distal end, and wherein the connecting assembly is a first connecting assembly, the roof mounted sensor pod assembly further having a second connecting assembly located between the first distal end and the second distal end and an interior sensor pod configured to couple to the second connecting assembly.

The roof mounted sensor pod assembly of any preceding clause, wherein the connecting assembly haves an opening formed in a forward surface of the frame, the opening configured to receive the sensor pod and support the weight of the sensor pod.

The roof mounted sensor pod assembly of any preceding clause, wherein the connecting assembly haves an opening formed in an upper surface of the frame, the opening configured to receive the sensor pod.

The roof mounted sensor pod assembly of any preceding clause, wherein the connecting assembly haves an opening formed in an aft surface of the frame, the opening configured to receive the sensor pod, and wherein the opening is located on an interior of the vehicle.

A vehicle having a windshield and a roof mounted sensor pod assembly connected to the vehicle above the windshield, the roof mounted sensor pod assembly having a frame and a sensor pod, wherein the frame is configured to support the weight of the sensor pod during installation of the sensor pod and prior to securing of the sensor pod to the frame.

The vehicle of the preceding clause, wherein the roof mounted sensor pod assembly is on an exterior of the vehicle.

The vehicle of any preceding clause, wherein the vehicle is autonomous or semi-autonomous.

The vehicle of any preceding clause, wherein the roof mounted sensor pod assembly is connected to a roof fairing of the vehicle or to a top surface of a roof of the vehicle.

The vehicle of any preceding clause, wherein a portion of the frame is accessible from an interior of the vehicle.

The vehicle of any preceding clause, wherein the sensor pod is rotatably mounted to the frame.

The vehicle of any preceding clause, wherein the sensor pod is removably attached to the frame.

The vehicle of any preceding clause, wherein the sensor pod includes a first side sensor pod at a first distal end of the frame, a second side sensor pod at a second distal end of the frame, and an interior sensor pod located between the first distal end of the frame and the second distal end of the frame.

The vehicle of any preceding clause, wherein each of the first side sensor pod, the second side sensor pod, and the interior sensor pod are removably mounted to the frame such that one or more of the first side sensor pod, the second side sensor pod, or the interior sensor pod may be removed and replaced or reinstalled on the frame.

The vehicle of any preceding clause, wherein the frame includes a connecting assembly having a post located on one of the frame and the sensor pod and a socket located on the other of the frame and the sensor pod. The socket is configured to receive the post to connect the sensor pod to the frame.

The vehicle of any preceding clause, wherein the frame includes a connecting assembly having an opening formed in a forward surface, an upper surface, or an aft surface of the frame, the opening configured to receive the sensor pod.

A roof mounted sensor pod assembly for a vehicle having a sensor pod configured to couple to the vehicle and a connecting assembly. The connecting assembly having a vehicle portion integral with the vehicle and a sensor pod portion attached to the sensor pod and removably coupled to the vehicle portion. The connecting assembly is configured to allow the sensor pod to be removably coupled to the vehicle.

The roof mounted sensor pod assembly of the preceding clause, wherein the vehicle portion includes a frame integral with the vehicle.

The roof mounted sensor pod assembly of any preceding clause, wherein the sensor pod is a first sensor pod and the connecting assembly is a first connecting assembly, wherein the first connecting assembly and the first sensor pod are located at a first distal end of the frame, assembly further having a second sensor pod and a second connecting assembly, the second connecting assembly and the second sensor pod located at a second distal end of the frame.

The roof mounted sensor pod assembly of any preceding clause, wherein the vehicle portion includes one or more brackets integral with the vehicle.

The roof mounted sensor pod assembly of any preceding clause, wherein the sensor pod is a first sensor pod, and wherein the one or more brackets include a first bracket configured to couple to the first sensor pod and a second bracket configured to couple to a second sensor pod.

The roof mounted sensor pod assembly of any preceding clause having an interior sensor pod configured to removably couple to the vehicle between the first bracket and the second bracket.

The roof mounted sensor pod assembly of any preceding clause, wherein the vehicle portion includes a post and the sensor pod portion includes a socket, the socket configured to receive the post.

The roof mounted sensor pod assembly of any preceding clause, wherein the post extends vertically upward from a ledge extending from the vehicle portion, the post and ledge configured to support the weight of the sensor pod when received within the socket.

The roof mounted sensor pod assembly of any preceding clause, wherein the post and the socket are configured to operate as an axle to allow rotation of the sensor pod with respect to the vehicle portion.

The roof mounted sensor pod assembly of any preceding clause, wherein the vehicle portion includes one or more hooks and the sensor pod portion includes one or more openings, the one or more openings configured to receive the hooks.

The roof mounted sensor pod assembly of any preceding clause, wherein each of the sensor pod and the vehicle portion has a longitudinal, centerline axis, and wherein the sensor pod has a first position where the longitudinal, centerline axes are misaligned and a second position where the longitudinal, centerline axes are aligned and coaxial.

The roof mounted sensor pod assembly of any preceding clause, wherein the sensor pod is configured to rotate between an uninstalled position and an installed position.

The roof mounted sensor pod assembly of any preceding clause, the sensor pod further having one or more conduits configured to couple to the vehicle.

The roof mounted sensor pod assembly of any preceding clause, wherein the sensor pod portion is rotatably coupled or slidably coupled to the vehicle portion.

The roof mounted sensor pod assembly of any preceding clause, wherein the connecting assembly is configured to support the weight of the sensor pod during installation of the sensor pod and prior to securing of the sensor pod to the vehicle portion.

A vehicle having a windshield and a roof mounted sensor pod assembly coupled above the windshield. The roof mounted sensor pod assembly has a sensor pod and a connecting assembly configured to couple the sensor pod to the vehicle. The connecting assembly has a vehicle portion integral with the vehicle and a sensor pod portion attached to the sensor pod and removably coupled to the vehicle portion. The connecting assembly is configured to removably couple the sensor pod to the vehicle.

The vehicle of the preceding clause, wherein the vehicle is autonomous or semi-autonomous.

The vehicle of any preceding clause, wherein the roof mounted sensor pod assembly is connected to a roof fairing of the vehicle or to a top surface of a roof of the vehicle.

The vehicle of any preceding clause, wherein the vehicle portion includes a frame integral with the vehicle.

The vehicle of any preceding clause, wherein the sensor pod haves a plurality of sensor pods, each of the plurality of sensor pods removably coupled to the frame.

The vehicle of any preceding clause, wherein the vehicle portion includes one or more brackets integral with the vehicle.

The vehicle of any preceding clause, wherein the sensor pod haves a plurality of sensor pods, each of the plurality of sensor pods removably coupled a respective bracket of the one or more brackets.

The vehicle of any preceding clause, wherein the vehicle portion includes a post and the sensor pod portion includes a socket, the socket configured to receive the post.

The vehicle of any preceding clause, wherein the vehicle portion includes one or more hooks and the sensor pod portion includes one or more openings, the one or more openings configured to receive the hooks.

The vehicle of any preceding clause, wherein each of the sensor pod and the vehicle portion has a longitudinal, centerline axis, and wherein the sensor pod has a first position where the longitudinal, centerline axes are misaligned and a second position where the longitudinal, centerline axes are aligned and coaxial.

The vehicle of any preceding clause, wherein the sensor pod portion is rotatably coupled or slidably coupled to the vehicle portion.

The vehicle of any preceding clause, wherein the connecting assembly is configured to support the weight of the sensor pod during installation of the sensor pod and prior to securing of the sensor pod to the vehicle portion.

A roof mounted sensor pod assembly for a vehicle having a bracket having a first distal side surface and a second distal side surface, the first distal side surface configured to attach to the vehicle, a connecting assembly located at the second distal side surface of the bracket, and a sensor pod configured to couple to the second distal side surface of the bracket, with the connecting assembly. The connecting assembly is configured to support the weight of the sensor pod during installation of the sensor pod and prior to securing of the sensor pod to the bracket.

The roof mounted sensor pod assembly of the preceding clause, wherein each of the sensor pod and the bracket has a longitudinal, centerline axis, and wherein the sensor pod has a first position where the longitudinal, centerline axes are misaligned and a second position where the longitudinal, centerline axes are aligned and coaxial.

The roof mounted sensor pod assembly of any preceding clause, wherein the sensor pod is configured to rotate between an uninstalled position and an installed position.

The roof mounted sensor pod assembly of any preceding clause having a post located on one of the bracket and the sensor pod and a socket located on the other of the bracket and the sensor pod. The socket is configured to receive the post to connect the sensor pod to the bracket.

The roof mounted sensor pod assembly of any preceding clause, wherein the post extends vertically upward from a ledge extending from the second distal side surface, the post and ledge configured to support the weight of the sensor pod when received within the socket.

The roof mounted sensor pod assembly of any preceding clause, wherein the post and the socket are configured to operate as an axle to allow rotation of the sensor pod with respect to the bracket.

The roof mounted sensor pod assembly of any preceding clause, the sensor pod further having one or more conduits configured to couple to the vehicle.

The roof mounted sensor pod assembly of any preceding clause, wherein the bracket is a first bracket, the connecting assembly is a first connecting assembly, and the sensor pod is a first side sensor pod. The roof mounted sensor pod assembly having a second bracket having a first distal side surface and a second distal side surface, the first distal side surface configured to attach to the vehicle, a second connecting assembly located at the second distal side surface of the second bracket, and a second side sensor pod configured to couple to the second distal side surface of the second bracket with the second connecting assembly.

The roof mounted sensor pod assembly of any preceding clause having an interior sensor pod configured to couple to the vehicle between the first bracket and the second bracket.

The roof mounted sensor pod assembly of any preceding clause, wherein the connecting assembly includes one or more hooks extending from the second distal side surface of the bracket and one or more openings extending from a side surface of the sensor pod, wherein the one or more openings are configured to receive the one or more hooks.

The roof mounted sensor pod assembly of any preceding clause, wherein the one or more hooks includes two hooks and the one or more openings includes two openings, each of the openings configured to receive a respective hook.

The roof mounted sensor pod assembly of any preceding clause, wherein the sensor pod is rotated vertically downward to secure the one or more hooks in the one or more openings.

The roof mounted sensor pod assembly of any preceding clause, wherein the sensor pod is slid laterally to secure the one or more hooks in the one or more openings.

A vehicle having a windshield and a roof mounted sensor pod assembly connected to the vehicle above the windshield, the roof mounted sensor pod assembly having a bracket and a sensor pod, wherein the bracket is configured to support the weight of the sensor pod during installation of the sensor pod and prior to securing of the sensor pod to the bracket.

The vehicle of the preceding clause, wherein the roof mounted sensor pod assembly is on an exterior of the vehicle.

The vehicle of any preceding clause, wherein the vehicle is autonomous or semi-autonomous.

The vehicle of any preceding clause, wherein the roof mounted sensor pod assembly is connected to a roof fairing of the vehicle or to a top surface of a roof of the vehicle.

The vehicle of any preceding clause, wherein the bracket has a first distal side surface and a second distal side surface, wherein the first distal side surface is attached to the vehicle and the second distal side surface is configured to attach to the sensor pod.

The vehicle of any preceding clause, wherein the sensor pod is rotatably mounted to the bracket.

The vehicle of any preceding clause, wherein the bracket is permanently attached to the vehicle and the sensor pod is removably attached to the bracket.

The vehicle of any preceding clause, wherein the bracket is a first bracket and the sensor pod is a first sensor pod, further having a second bracket and a second sensor pod configured to couple to the second bracket, wherein the first bracket is coupled above the windshield on a driver's side of the vehicle and the second bracket is coupled above the windshield on a passenger's side of the vehicle.

The vehicle of any preceding clause, further having an interior sensor pod located between the first sensor pod and the second sensor pod.

The vehicle of any preceding clause, wherein each of the first sensor pod, the second sensor pod, and the interior sensor pod are removably mounted to the vehicle such that one or more of the first sensor pod, the second sensor pod, or the interior sensor pod may be removed and replaced or reinstalled on the vehicle.

The vehicle of any preceding clause, wherein the bracket includes a connecting assembly having a post located on one of the bracket and the sensor pod and a socket located on the other of the bracket and the sensor pod. The socket is configured to receive the post to connect the sensor pod to the vehicle.

The vehicle of any preceding clause, wherein the bracket includes a connecting assembly having one or more hooks extending from the bracket and one or more openings extending from a side surface of the sensor pod, wherein the one or more openings are configured to receive the one or more hooks.

The vehicle of any preceding clause, wherein the vehicle haves an opening formed in a forward surface of the vehicle, the opening configured to receive an interior sensor pod.

The vehicle of any preceding clause, wherein the vehicle haves an opening formed in an interior of the vehicle and a window, the opening configured to receive an interior sensor pod and the window configured to permit a field of view of the interior sensor pod in the forward direction of the vehicle.

A method of installing a sensor pod on a roof of a vehicle, the method including providing a connecting assembly having a vehicle portion configured to couple to the vehicle and a sensor pod portion attached to the sensor pod, installing the vehicle portion of the connecting assembly on the vehicle, coupling the sensor pod portion of the connecting assembly to the vehicle portion, after coupling the sensor pod portion to the vehicle portion, supporting the weight of the sensor pod with the connecting assembly, and securing the sensor pod to the vehicle portion of the connecting assembly. The connecting assembly supports the weight of the sensor pod before and after securing the sensor pod to the vehicle portion.

The method of the preceding clause, wherein the vehicle portion is permanently installed on the vehicle or integral with the vehicle.

The method of any preceding clause, wherein installing the vehicle portion of the connecting assembly haves installing a frame or a bracket on the vehicle.

The method of any preceding clause, wherein coupling the sensor pod portion to the vehicle portion haves sliding the sensor pod into an opening.

The method of any preceding clause, wherein coupling the sensor pod portion to the vehicle portion haves receiving a post within a socket.

The method of any preceding clause, wherein coupling the sensor pod portion to the vehicle portion haves receiving a hook within an opening.

The method of any preceding clause, wherein securing the sensor pod to the vehicle portion haves fastening the sensor pod to the vehicle portion.

The method of any preceding clause, further having removing the sensor pod and installing a new sensor pod on the vehicle portion of the connecting assembly.

The method of any preceding clause, wherein the installing, coupling, and securing are performed by a single operator.

The method of any preceding clause, wherein installing the vehicle portion of the connecting assembly haves installing a frame on the vehicle, and wherein the sensor pod is a first sensor pod and the method haves installing the first sensor pod on a first distal end of the frame and installing a second sensor pod on a second distal end of the frame.

The method of any preceding clause, wherein the vehicle portion of the connecting assembly is secured to the vehicle above a windshield of the vehicle.

The method of any preceding clause, further having rotating the sensor pod into axial alignment with the vehicle portion of the connecting assembly before securing the sensor pod to the vehicle portion of the connecting assembly.

The method of any preceding clause, wherein coupling the sensor pod portion to the vehicle portion haves aligning a socket on the sensor pod with a post on the vehicle portion of the connecting assembly; and receiving the post in the socket.

A method of uninstalling a sensor pod on a roof of a vehicle unsecuring a sensor pod portion of a connecting assembly from a vehicle portion of the connecting assembly, disconnecting one or more conduits from the sensor pod, removing the sensor pod portion from the vehicle portion to disconnect the sensor pod from the roof of the vehicle, and removing the sensor pod, wherein the vehicle portion is permanently fixed to the vehicle.

The method of the preceding clause, further having installing another sensor pod on the vehicle portion of the connecting assembly after removing the sensor pod portion.

The method of any preceding clause, wherein disconnecting the sensor pod portion from the vehicle portion haves sliding the sensor pod portion laterally with respect to the vehicle portion.

The method of any preceding clause, wherein disconnecting the sensor pod portion from the vehicle portion haves rotating the sensor pod portion with respect to the vehicle portion and then lifting the sensor pod portion vertically away from the vehicle portion.

The method of any preceding clause, wherein disconnecting the sensor pod portion from the vehicle portion haves removing a socket of the sensor pod portion from a post of the vehicle portion.

The method of any preceding clause, wherein disconnecting the sensor pod portion from the vehicle portion haves removing one or more openings of the sensor pod portion from one or more hooks of the vehicle portion.

The method of any preceding clause, removing the sensor pod portion haves sliding the sensor pod laterally out of an opening, wherein the vehicle portion is the opening.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A method of installing a sensor pod on a roof of a vehicle, the method comprising:
providing a connecting assembly having a vehicle portion configured to couple to the vehicle and a sensor pod portion attached to the sensor pod;
installing the vehicle portion of the connecting assembly on the vehicle;
coupling the sensor pod portion of the connecting assembly to the vehicle portion;
after coupling the sensor pod portion to the vehicle portion, supporting the weight of the sensor pod with the connecting assembly; and
securing the sensor pod to the vehicle portion of the connecting assembly,
wherein the connecting assembly supports the weight of the sensor pod before and after securing the sensor pod to the vehicle portion.

2. The method of claim 1, wherein the vehicle portion is permanently installed on the vehicle or integral with the vehicle.

3. The method of claim 1, wherein installing the vehicle portion of the connecting assembly comprises installing a frame or a bracket on the vehicle.

4. The method of claim 1, wherein coupling the sensor pod portion to the vehicle portion comprises sliding the sensor pod into an opening.

5. The method of claim 1, wherein coupling the sensor pod portion to the vehicle portion comprises receiving a post within a socket.

6. The method of claim 1, wherein coupling the sensor pod portion to the vehicle portion comprises receiving a hook within an opening.

7. The method of claim 1, wherein securing the sensor pod to the vehicle portion comprises fastening the sensor pod to the vehicle portion.

8. The method of claim 1, further comprising removing the sensor pod and installing a new sensor pod on the vehicle portion of the connecting assembly.

9. The method of claim 1, wherein the installing, coupling, and securing are performed by a single operator.

10. The method of claim 1, wherein installing the vehicle portion of the connecting assembly comprises installing a frame on the vehicle, and wherein the sensor pod is a first sensor pod and the method comprises installing the first sensor pod on a first distal end of the frame and installing a second sensor pod on a second distal end of the frame.

11. The method of claim 1, wherein the vehicle portion of the connecting assembly is secured to the vehicle above a windshield of the vehicle.

12. The method of claim 1, further comprising rotating the sensor pod into axial alignment with the vehicle portion of the connecting assembly before securing the sensor pod to the vehicle portion of the connecting assembly.

13. The method of claim 1, wherein coupling the sensor pod portion to the vehicle portion comprises aligning a socket on the sensor pod with a post on the vehicle portion of the connecting assembly; and receiving the post in the socket.

14. A method of uninstalling a sensor pod on a roof of a vehicle, the method comprising:
unsecuring a sensor pod portion of a connecting assembly from a vehicle portion of the connecting assembly;
disconnecting one or more conduits from the sensor pod;
removing the sensor pod portion from the vehicle portion to disconnect the sensor pod from the roof of the vehicle; and
removing the sensor pod, wherein the vehicle portion is permanently fixed to the vehicle.

15. The method of claim 14, further comprising installing another sensor pod on the vehicle portion of the connecting assembly after removing the sensor pod portion.

16. The method of claim 14, wherein disconnecting the sensor pod portion from the vehicle portion comprises sliding the sensor pod portion laterally with respect to the vehicle portion.

17. The method of claim 14, wherein disconnecting the sensor pod portion from the vehicle portion comprises rotating the sensor pod portion with respect to the vehicle portion and then lifting the sensor pod portion vertically away from the vehicle portion.

18. The method of claim 14, wherein disconnecting the sensor pod portion from the vehicle portion comprises removing a socket of the sensor pod portion from a post of the vehicle portion.

19. The method of claim 14, wherein disconnecting the sensor pod portion from the vehicle portion comprises removing one or more openings of the sensor pod portion from one or more hooks of the vehicle portion.

20. The method of claim 14, removing the sensor pod portion comprises sliding the sensor pod laterally out of an opening, wherein the vehicle portion is the opening.
